(19) United States
(12) Patent Application Publication
(10) Pub. No.: US 2009/0153938 A1
(43) Pub. Date: Jun. 18, 2009

(54) Method for enhanced detection of faint targets in systems employing an external occulter

(76) Inventors: Jonathan W. Arenberg, Santa Monica, CA (US); Amy Shiu-Mei Lo, Redondo Beach, CA (US); Tiffany Michelle Glassman, Altadena, CA (US)

Correspondence Address: Carmen Patti Group , LLC, ONE NORTH LASALLE STREET, 44TH FLOOR, CHICAGO, IL, 60602, US

(21) Appl. No.: 12/002,575

(22) Filed: Dec. 18, 2007

(51) Int. Cl. G02B 26/04

(52) U.S. Cl. 359/234

(57) ABSTRACT

One embodiment of the present method and apparatus encompasses a method having the steps of: locating a rotateable occulter between a star having at least one planet and a light detector for detecting light from the star and the planet, the rotateable occulter having a central circular obscuration, and a plurality of hypergaussian-shaped petals that are located around the central circular obscuration; substantially blocking on axis light from the star with the central circular obscuration; rotating the occulter such that light from the planet oscillates due to changing azimuthal orientation; synchronizing the light from the planet to orientation of the occulter; and detecting off-axis light from the planet with the light detector.

### TECHNICAL FIELD

The invention relates generally to occulters and, more particularly, to external occulters used in detection of faint targets.

### BACKGROUND

Currently, the direct detection of extrasolar planets (or exoplanets) and especially small terrestrial (Earth-like) is extremely difficult. This is primarily because exoplanets appear extremely close to their host stars when observed at astronomical distances. Also, exoplanets are incredibly dim compared to their host stars. Typically, the star will be approximately ten billion times brighter than the orbiting terrestrial planet. This makes it near-impossible to see planets against the star's glare. The difficulty of observing such a dim planet so close to a bright star is the obstacle that has prevented astronomers from directly photographing exoplanets.

It has been proposed to use an occulter to overcome the difficulty of distinguishing a planet in the glare of a bright star. The occulter would block all of the starlight from reaching the observing, while allowing the planet's light to pass undisturbed. This would allow the direct observation of orbiting planets.

The occulter may be a large sheet disc flown thousands of kilometers along the line of sight. The disc would likely be several tens of meters in diameter. One difficulty with this concept is that light incoming from the target star would diffract around the disc and constructively interfere along the central axis. Thus the starlight would still be easily visible, making planet detection impossible. Fortunately this effect can be negated by specifically shaping the occulter, by adding specially shaped petals to the outer edge of the disc. The starlight will disappear, allowing the direct observation of the exo-planet's light.

### SUMMARY

One embodiment of the present method and apparatus encompasses an apparatus. The apparatus may comprise: a rotateable occulter having a plurality of petals; and wherein light from a planet that oscillates due to changing azimuthal orientation, is synchronized to orientation of the occulter.

Another embodiment of the present method and apparatus encompasses a method. This method may comprise: locating a rotateable occulter between a star having at least one planet and a light detector for detecting light from the star and the planet, the rotateable occulter having a central circular obscuration, and a plurality of hypergaussian-shaped petals that are located around the central circular obscuration; substantially blocking on axis light from the star with the central circular obscuration; rotating the occulter such that light from the planet oscillates due to changing azimuthal orientation; synchronizing the light from the planet to orientation of the occulter; and detecting off-axis light from the planet with the light detector.

A further embodiment of the present method and apparatus encompasses an apparatus. This apparatus may comprise: a rotateable occulter disposed between a star having at least one planet and a light detector for detecting light from the star and the planet; the rotateable occulter having a plurality of petals; and wherein on axis light from the star is substantially blocked, and wherein light from the planet that oscillates due to changing azimuthal orientation, is synchronized to orientation of the occulter, therefore allowing off-axis light from the planet to be seen by the light detector.

### DESCRIPTION OF THE DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 depicts one example of the basic architecture of an apparatus for detecting off axis light from a planet.

FIG. 2 depicts one embodiment in more detail of the occulter according to the present method and apparatus.

FIG. 3 depicts one embodiment of an occulter according to the present method and apparatus in which three zones are identified.

FIG. 4 is a graph of offset v. normalized intensity for the FIG. 3 apparatus.

FIG. 5 depicts one embodiment of a method for detecting off axis light from a planet according to the present method and apparatus.

### DETAILED DESCRIPTION

In order to prevent the incredibly bright star from overwhelming a planet's much dimmer light, the starlight may be blocked with an occulter. An occulter is simply an object that prevents light from another object from reaching the observer. For example, during a solar eclipse, the moon occults the sun. By making a large enough disc and launching it into space any star's light may be blocked out, allowing the planets around the star to be viewed.

The basic concept for this design is reasonably simple. However there are details that must be considered with this idea. The most challenging obstacle is caused by diffraction. Diffraction is the bending of waves around a corner. Thus the starlight hitting the edge of the occulting disc will diffract around the edge and still be visible, defeating the purpose of the occulter.

When two waves of light meet, they interfere with each other. If the two waves are “in phase” (i.e. their crests and troughs line up) then the waves interfere constructively. This means that the two waves add together to create a bright spot. If the two waves are out of phase (the crests of one wave line up with the troughs of another), then they combine destructively. This means that the two waves effectively cancel each other out, leaving a dark spot.

If one were to use the disc shaped occulter and stand behind it, one would still see a bright spot. Because the light traveling around the disc all travels the same length to reach one's eyeball, they are all in phase with each other, thus they constructively interfere.

Fortunately, by specially designing the occulting disc, the constructive diffraction may be eliminated. By adding petals onto the disc's edge, the path length of each ray of light is offset just enough so that the combined effect is destructive interference. As the light waves diffract around the petals, each ray of light will destructively interfere with another ray, therefore no light will be seen if one stands behind the starshade. The shadow created behind the occulter will be large enough to fly a space telescope within. By flying in the starshade's shadow, the telescope will be able to look for the faint planet-light without being blinded by the star's light.

Currently, the direct detection of extrasolar planets (or exoplanets) and especially terrestrial sized exoplanets is extremely difficult. This is primarily due to the fact that terrestrial exoplanets appear extremely close to their host stars when observed at astronomical distances. Even the closest of stars are several light years away. This means that while looking for terrestrial exoplanets, one would typically be observing very small angles from the star, on the order of several tens of milli-arcseconds. Angles this small are impossible to resolve from the ground due to the blurring and twinkling of astronomical objects such as stars caused by turbulence in the Earth's atmosphere. Exoplanets are incredibly dim compared to their host stars. Typically, the star will be approximately a billion times brighter than the orbiting planet. This makes it near-impossible to see planets against the star's glare without the embodiments of the present method and apparatus.

The principles of the present method and apparatus may be used in a variety of different embodiments. For example, in order to see planets against the star's glare the occulter of the present method and apparatus may be used in the New Worlds Observer (NWO) project. In general, embodiments of the present method and apparatus address the signal detection problem. A weak planetary signal is subject to noise. By rotating the occulter and synchronously detecting the planetary signal one takes advantage of the intrinsic narrow bandwidth of the synchronous detection process to reject noise, both random and artificial, assuming the latter is not periodic with the occulter rotation.

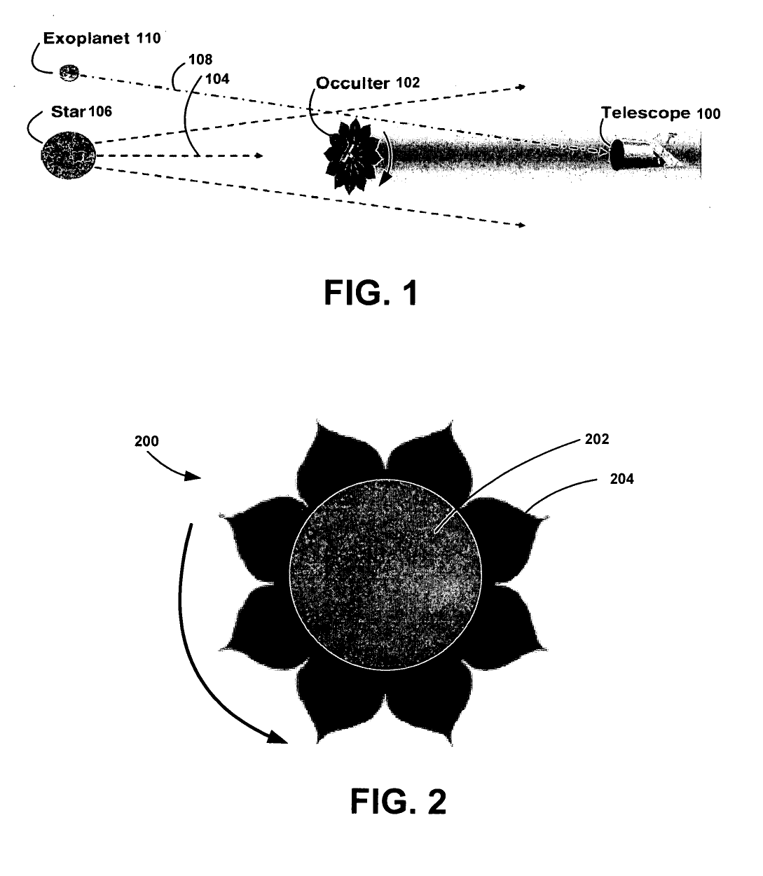

FIG. 1 depicts one example of the basic architecture of an apparatus for detecting off axis light from a terrestrial planet. A generic telescope 100 is used in conjunction with an occulter 102 to block out the on axis starlight 104 from a star 106 and detect on axis light 108 in order to characterize an off axis source, such as an exoplanet 110. It is a feature of the present method and apparatus that the occulter 102 may rotate.

FIG. 2 depicts one embodiment in more detail of the occulter according to the present method and apparatus. The occulter 200 is capable of creating a given contrast ratio at all radial angles greater than some minimum, called the Inner Working Angle (IWA). The occulter 200 may be fully opaque and have a central circular obscuration 202 and a plurality of hypergaussian-shaped petals 204 that are located around the central circular obscuration 204. The distinctive flower-petal shape produces destructive interference of on axis light and virtually no suppression outside of the IWA. Since the starlight is extinguished by the occulter, but the target planets are unattenuated, the entire extra-solar system may be observed from the IWA out to the edge of the field of view of the telescope. By having no outer view restrictions, background objects and field stars are simultaneously in view, enabling accurate astrometry to determine the precise location of the planet relative to its parent star.

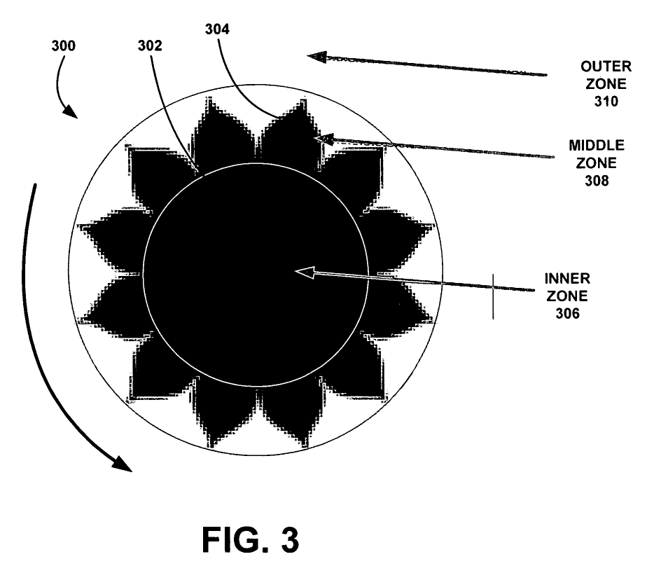

FIG. 3 depicts one embodiment of an occulter according to the present method and apparatus in which three zones are identified. As previously described the occulter 300 has a central circular obscuration 302 and a plurality of hypergaussian-shaped petals 304 that are located around the central circular obscuration 304. With this configuration there may be defined an inner zone 306, a middle zone 308, and an outer zone 310. The inner zone 306 corresponds to an area of the central circular obscuration 302. The middle zone 308 corresponds to an area of the plurality of hypergaussian-shaped petals 304. The outer zone 310 corresponds to an area outside of the central circular obscuration 302 and the plurality of hypergaussian-shaped petals 304. Thus, if a planet is located in the inner zone 306, there is no transmission of light from the planet, if the planet is located in the middle zone 308, there is a partial transmission of light from the planet, and if the planet is in the outer zone 310, there is a total transmission of light from the planet.

However, there is a phenomenon for planets, which reside in the middle zone 308 and just into the outer zone 310. Namely, that there is an azimuthal dependence on the strength of the detected signal from the planet. Calculations of diffraction and the strength of the planet signal at various radial angles, and for two different azimuthal locations (one behind the petal and one between) have been made.

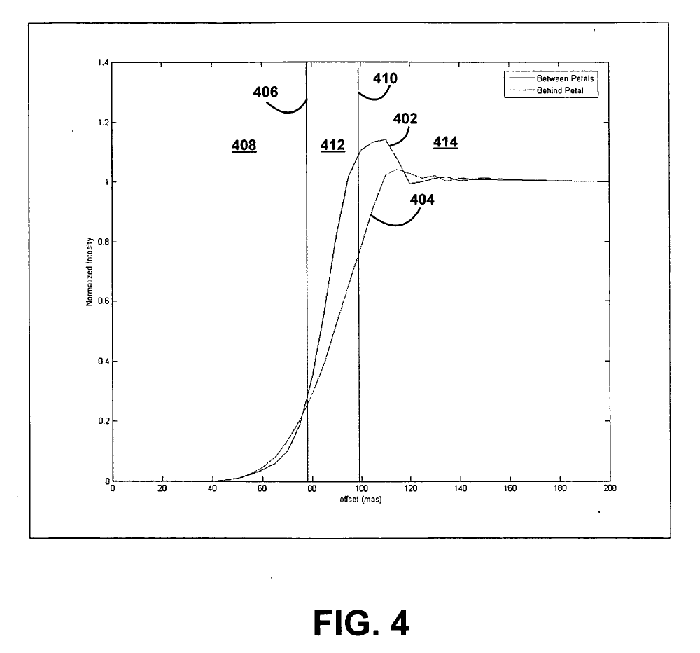

FIG. 4 is a graph of offset v. normalized intensity for the FIG. 3 apparatus. In FIG. 4, the first trace 402 is for the signal when the planet is behind the petal and the second trace 404 for when the planet is between two petals. The area of the plot to the left of the first vertical line 406 is essentially the inner zone 408, the area between the two lines 406, 410 is essentially the middle zone 412, and the outer zone 414 is to the right of the second line 410. In the middle zone 412 and the beginning of the outer zone 414 there is a noticeable increase in signal when the planet is hidden behind a petal. This FIG. 4 is the result of a single set of design parameters and is used to show the order of magnitude of the effect. In a real design problem, analysis of this type will be used to determine petal number and the hypergaussian order, along with other factors.

Embodiments of the present method and apparatus utilize this azimuthal dependence in a simple manner. Namely, the occulter is rotated around its axis. This rotation then places the planet both behind and between petals. This changing azimuthal orientation will cause the planet signal, that is detected light from the planet, to oscillate, which is then synchronized to the orientation of the occulter.

This then turns the detection problem from one of finding a fixed source in noise to one that can be synchronously detected. This reduces the impact of noise on detectability and allows smaller occulters to perform to the same mission requirements as a larger occulter with out such a rotation.

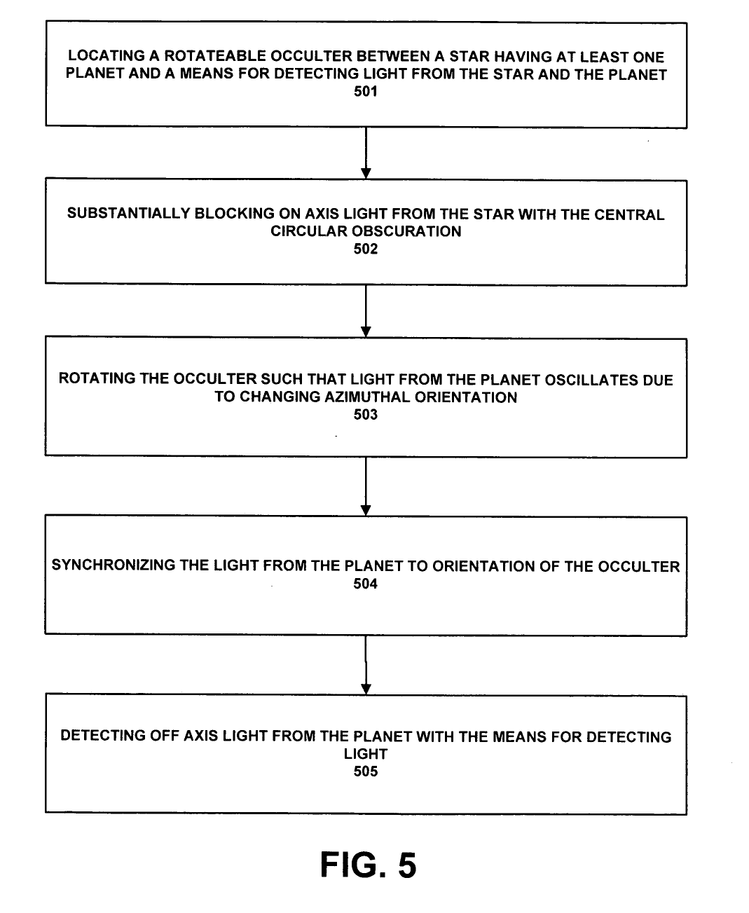

FIG. 5 depicts one embodiment of a method for detecting off axis light from a planet according to the present method and apparatus. This method may comprise: locating a rotateable occulter between a star having at least one planet and a light detector for detecting light from the star and the planet, the rotateable occulter having a central circular obscuration, and a plurality of hypergaussian-shaped petals that are located around the central circular obscuration, step 501; substantially blocking on axis light from the star with the central circular obscuration, step 502; rotating the occulter such that light from the planet oscillates due to changing azimuthal orientation, step 503; synchronizing the light from the planet to orientation of the occulter, step 504; and detecting off axis light from the planet with the light detector, step 505.

The present method and apparatus are not limited to the particular details of the depicted embodiments and other modifications and applications are contemplated. Certain other changes may be made in the above-described embodiments without departing from the true spirit and scope of the present method and apparatus herein involved. It is intended, therefore, that the subject matter in the above depiction shall be interpreted as illustrative and not in a limiting sense.

We claim:

1. An apparatus, comprising:
a rotateable occulter having a plurality of petals; and
wherein light from a planet that oscillates due to changing azimuthal orientation, is synchronized to orientation of the occulter.

2. The apparatus according to claim 1, wherein the rotateable occulter has a central circular obscuration, and a plurality of hypergaussian-shaped petals that are located around the central circular obscuration.

3. The apparatus according to claim 2, wherein the rotateable occulter has three zones, an inner zone, a middle zone, and an outer zone.

4. The apparatus according to claim 3, wherein the inner zone corresponds to an area of the central circular obscuration.

5. The apparatus according to claim 3, wherein the middle zone corresponds to an area of the plurality of hypergaussian-shaped petals.

6. The apparatus according to claim 3, wherein the outer zone corresponds to an area outside of the central circular obscuration and the plurality of hypergaussian-shaped petals.

7. The apparatus according to claim 3, wherein if a planet is located in the inner zone, there is no transmission of light from the planet, if the planet is located in the middle zone, there is a partial transmission of light from the planet, and if the planet is in the outer zone, there is a total transmission of light from the planet.

8. The apparatus according to claim 3, wherein for planets which reside in the middle zone and just into the outer zone there is an azimuthal dependence on a strength of the detected signal from the planet.

9. The apparatus according to claim 1, wherein the rotateable occulter suppresses on-axis starlight, yet allows off-axis light from the planet to be seen.

10. An apparatus, comprising:
a rotateable occulter disposed between a star having at least one planet and a light detector from the star and the planet;
the rotateable occulter having a plurality of petals; and
wherein on axis light from the star is substantially blocked, and wherein light from the planet that oscillates due to changing azimuthal orientation, is synchronized to orientation of the occulter, therefore allowing off-axis light from the planet to be seen by the light detector.

11. The apparatus according to claim 10, wherein the rotateable occulter has a central circular obscuration, and a plurality of hypergaussian-shaped petals that are located around the central circular obscuration.

12. The apparatus according to claim 11, wherein the rotateable occulter has three zones, an inner zone, a middle zone, and an outer zone.

13. The apparatus according to claim 12, wherein the inner zone corresponds to an area of the central circular obscuration.

14. The apparatus according to claim 12, wherein the middle zone corresponds to an area of the plurality of hypergaussian-shaped petals.

15. The apparatus according to claim 12, wherein the outer zone corresponds to an area outside of the central circular obscuration and the plurality of hypergaussian-shaped petals.

16. The apparatus according to claim 12, wherein if a planet is located in the inner zone, there is no transmission of light from the planet, if the planet is located in the middle zone, there is a partial transmission of light from the planet, and if the planet is in the outer zone, there is a total transmission of light from the planet.

17. The apparatus according to claim 12, wherein for planets which reside in the middle zone and just into the outer zone there is an azimuthal dependence on a strength of the detected light from the planet.

18. A method comprising the steps of:
locating a rotateable occulter between a star having at least one planet and a light detector that detects light from the star and the planet, the rotateable occulter having a central circular obscuration, and a plurality of hypergaussian-shaped petals that are located around the central circular obscuration; and
substantially blocking on axis light from the star with the central circular obscuration;
rotating the occulter such that light from the planet oscillates due to changing azimuthal orientation;
synchronizing the light from the planet to orientation of the occulter; and
detecting off-axis light from the planet.

19. The method according to claim 18, wherein the rotateable occulter has three zones, an inner zone, a middle zone, and an outer zone, wherein the inner zone corresponds to an area of the central circular obscuration, wherein the middle zone corresponds to an area of the plurality of hypergaussian-shaped petals, wherein the outer zone corresponds to an area outside of the central circular obscuration and the plurality of hypergaussian-shaped petals, and wherein if a planet is located in the inner zone, there is no transmission of light from the planet, if the planet is located in the middle zone, there is a partial transmission of light from the planet, and if the planet is in the outer zone, there is a total transmission of light from the planet.

20. The method according to claim 19, wherein for planets which reside in the middle zone and just into the outer zone there is an azimuthal dependence on a strength of the detected light from the planet.
